(19) United States
(12) Patent Application Publication
(10) Pub. No.: US 2026/0006644 A1
(43) Pub. Date: Jan. 1, 2026

(54) STATION, ACCESS POINT AND METHOD FOR LOW LATENCY TRAFFIC IN WIRELESS NETWORKS

(71) Applicant: InterDigital Patent Holdings, Inc., Wilmington, DE (US)

(72) Inventors: Hanqing Lou, Syosset, NY (US); Xiaofei Wang, North Caldwell, NJ (US)

(21) Appl. No.: 18/757,204

(22) Filed: Jun. 27, 2024

(51) Int. Cl. H04W 74/0816; H04W 28/02

(52) U.S. Cl. CPC H04W 74/0816; H04W 28/0268

(57) ABSTRACT

Methods, apparatuses, and/or systems relating to low latency traffic in wireless networks are provided. One method may include transmitting, to an Access Point (AP), a frame comprising one or more fields or subfields for indicating the STA supports Low Latency Traffic Indicator (LLTI) communications with a first group of other STAs associated with the AP that support the Low Latency Traffic Indicator (LLTI) communications. The method may include receiving, from the AP, a first control frame indicating a permitted transmission of LLTI communications during a first TXOP, transmitting, an LLTI signal during the first TXOP, and transmitting, data having a low latency requirement relative to other data traffic based on the transmitted LLTI frame.

### TECHNICAL FIELD

The present disclosure is generally directed to the fields of communications, software and encoding, including methods, architectures, apparatuses, and systems directed to wireless networks, including notably nodes (e.g. access points, user equipment, wireless devices) have low latency requirements.

### BACKGROUND

A Wireless Local Area Network (WLAN) in Infrastructure Basic Service Set (BSS) mode has an Access Point (AP) for the BSS and one or more stations (STAs) associated with the AP. An example of WLAN Medium Access Control (MAC and Physical Layer (PHY) is disclosed in IEEE Std 802.11™-2020 specifications. Some additional specifications are defined in IEEE P802.11be™-D6.0, as published in May 2024. The AP typically has access or interface to a Distribution System (LLTI) or another type of wired/wireless network that carries traffic in and out of the BSS. Traffic to STAs that originates from outside the BSS arrives through the AP and is delivered to the STAs. Traffic originating from STAs to destinations outside the BSS is sent to the AP to be delivered to the respective destinations. Traffic between STAs within the BSS may also be sent through the AP where the source STA sends traffic to the AP and the AP delivers the traffic to the destination STA. Such traffic between STAs within a BSS is really peer-to-peer traffic. Such peer-to-peer traffic may also be sent directly between the source and destination STAs with a direct link setup (DLS) using an 802.11e DLS or an 802.11z tunneled DLS (TDLS). A WLAN using an Independent BSS (IBSS) mode has no AP, and/or STAs, communicating directly with each other. This mode of communication is referred to as an “ad-hoc” mode of communication.

Using the 802.11ac infrastructure mode of operation, the AP may transmit a beacon on a fixed channel, usually the primary channel. This channel may be 20 MHz wide, and is the operating channel of the BSS. This channel is also used by the STAs to establish a connection with the AP. The fundamental channel access mechanism in an 802.11 system is Carrier Sense Multiple Access with Collision Avoidance (CSMA/CA). In this mode of operation, every STA, including the AP, will sense the occupancy or vacancy of the primary channel. If the channel is detected to be busy, the STA backs off. Hence only one STA may transmit at any given time in a given BSS.

In 802.11n, High Throughput (HT) STAs may also use a 40 MHz wide channel for communication. This is achieved by combining the primary 20 MHz channel, with an adjacent 20 MHz channel to form a 40 MHz wide contiguous channel.

In 802.11ac, Very High Throughput (VHT) STAs may support 20 MHz, 40 MHz, 80 MHz, and 160 MHz wide channels. The 40 MHz, and 80 MHz, channels are formed by combining contiguous 20 MHz channels similar to 802.11n described above. A160 MHz channel may be formed either by combining 8 contiguous 20 MHz channels, or by combining two non-contiguous 80 MHz channels, this may also be referred to as an 80+80 configuration. For the 80+80 configuration, at the transmitter, the data, after channel encoding, is passed through a segment parser that divides it into two streams. IFFT and time domain processing are done on each stream separately. The streams are then mapped on to the two channels, and the data is transmitted. At the receiver, this mechanism is reversed, and the combined data is sent to the MAC.

Sub 1 GHz modes of operation are supported by 802.11af, and 802.11ah, For these specifications the channel operating bandwidths, and carriers, are reduced relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHZ, 4 MHZ, 8 MHz, and 16 MHz bandwidths using non-TVWS spectrum. A possible use case for 802.11ah is support for Meter Type Control (MTC) devices in a macro coverage area. MTC devices may have limited capabilities including only support for limited bandwidths, but also include a requirement for a very long battery life.

WLAN systems which support multiple channels, and channel widths, such as 802.11n, 802.11ac, 802.11af, and 802.11ah, include a channel which is designated as the primary channel. The primary channel may, but not necessarily, have a bandwidth equal to the largest common operating bandwidth supported by all STAs in the BSS. The bandwidth of the primary channel is therefore limited by the STA, of all STAs in operating in a BSS, which supports the smallest bandwidth operating mode. In the example of 802.11ah, the primary channel may be 1 MHz wide if there are STAs (e.g. MTC type devices) that only support a 1 MHz mode even if the AP, and other STAs in the BSS, may support a 2 MHz, 4 MHz, 8 MHz, 16 MHz, or other channel bandwidth operating modes. All carrier sensing, and NAV settings, depend on the status of the primary channel; i.e., if the primary channel is busy, for example, due to a STA supporting only a 1 MHz operating mode is transmitting to the AP, then the entire available frequency bands are considered busy even though majority of it stays idle and available.

In the United States, the available frequency bands which may be used by 802.11ah are from 902 MHz to 928 MHz. In Korea it is from 917.5 MHz to 923.5 MHz; and in Japan, it is from 916.5 MHz to 927.5 MHz. The total bandwidth available for 802.11ah is 6 MHz to 26 MHz depending on the country code.

According to existing channel access procedure, we may consider basic channel access. IEEE 802.11 STAs usually perform random backoff procedure before transmitting for each contention period.

When a STA determines that the medium is idle and a frame is queued for transmission, and wireless medium remains idle for a period of a DIFS, or an EIFS from the end of the immediately preceding medium-busy event, it may invoke a random backoff procedure if the backoff counter has a non-zero value. The STA may start transmitting if the wireless medium remains idle after the backoff counter reaches 0. The backoff counter is set to an integer value chosen randomly with a uniform distribution between 0 to CW, where CW is an integer value between aCWmin and aCWmax. aCWmin and aCWmax are values set by the AP. The system will set the initial value of CW as aCWmin. CW is doubled when a collision or transmission failure occurs. The CW value is capped by aCWmax. The CW is reset to aCWmin after every successful transmission.

When the backoff procedure is invoked, the backoff counter initially is set to an integer value chosen randomly with a uniform distribution taking values in the range 0 to CW[AC]. AC here is an index corresponding to an access category. If no medium activity is indicated for the duration of a particular backoff slot, then the backoff procedure shall decrement its backoff counter.

An IEEE 802.11 Ultra High Reliability (UHR) Study Group was formed in September 2022. UHR is considered as the next major revision to IEEE 802.11 standards following 802.11be, which is currently in the Working Group Letter Ballot Stage. UHR is formed to explore the possibility to improve reliability, support low latency traffic and further increase peak throughput and improve efficiency of the IEEE 802.11 networks.

To support low latency traffic transmission, several contributions have been proposed to allow STAs with low latency traffic to transmit a signal without back off in a contention period. The signal is referred as a Defer Signal in some contributions (for example, document referred as 11-23/2126 entitled “Low Latency channel access”). After the transmission of the Defer Signal, the STAs without low latency traffic may hold their contention and wait for next transmission opportunity. The STAs which transmitted the Defer Signal may start a backoff. The purpose of the backoff is to reduce the chance of collision when more than one STAs transmit the Defer Signal concurrently.

Other contributions have been proposed including (for example, document referred as 11-24/00311r0 and entitled “deterministic backoff”) in which STAs with low latency traffic may apply deterministic backoff and using Interruptions per TXOP parameters to self organize into a backoff order that is more deterministic than the traditional EDCA channel access.

Other approaches to address low latency channel access including preemptions. For example, in document referred as 11-24/168r0-TXPO Preemption in 11bn″, proposals have been made to have STAs with low latency traffic gain early channel access during other STAs' TXOPs to ensure sufficient delays.

### SUMMARY

One or more of the foregoing issues or needs may be addressed by aspects of the embodiments disclosed herein.

Certain example embodiments may include a station (STA) comprising a transceiver and a processor. The transceiver and processor may be configured to transmit, to an Access Point (AP), a frame comprising one or more fields or subfields for indicating the STA allows Low Latency Traffic Indicator (LLTI) communications within a first group of other STAs associated with the AP that allows the low latency traffic Indicator (LLTI) communications. The transceiver and processor may be configured to receive, from an Access Point (AP), a first control frame indicating a permitted transmission of LLTI communications during a first TXOP, to transmit an LLTI signal during the first TXOP, and to transmit, during the first TXOP, data having a low latency requirement following the transmitted LLTI signal.

Certain example embodiments may include a method for use in a station (STA). The method may include transmitting, to an Access Point (AP), a frame comprising one or more fields or subfields for indicating the STA supports Low Latency Traffic Indicator (LLTI) communications with a first group of other STAs associated with the AP that support the Low Latency Traffic Indicator (LLTI) communications. The method may include receiving, from the AP, a first control frame indicating a permitted transmission of LLTI communications during a first TXOP, transmitting, an LLTI signal during the first TXOP, and transmitting, data having a low latency requirement relative to other data traffic based on the transmitted LLTI frame.

Certain example embodiments may include an access point (AP) comprising a transceiver and a processor. The transceiver and processor may be configured to receive, from a wireless station (STA), a frame comprising one or more fields or subfields for indicating the STA supports Low Latency Traffic Indicator (LLTI) communications with a first group of other STAs associated with the AP that support the Low Latency Traffic Indicator (LLTI) communications. The transceiver and processor may be configured to transmit, to the STA, a first control frame indicating a permitted transmission of LLTI communications during a first TXOP, to receive, an LLTI signal during the first TXOP, and to receive, data having a low latency requirement relative to other data traffic based on the received LLTI signal.

Certain example embodiments may include a method for use in an access point (AP). The method may include receiving, from a wireless station (STA), a frame comprising one or more fields or subfields for indicating the STA supports Low Latency Traffic Indicator (LLTI) communications with a first group of other STAs associated with the AP that support the Low Latency Traffic Indicator (LLTI) communications. The method may include transmitting, to the STA, a first control frame indicating a permitted transmission of LLTI communications during a first TXOP, receiving, an LLTI signal during the first TXOP, and receiving, data having a low latency requirement relative to other data traffic based on the received LLTI signal.

### BRIEF DESCRIPTION OF THE DRAWINGS

A more detailed understanding may be had from the detailed description below, given by way of example in conjunction with drawings appended hereto. Figures in such drawings, like the detailed description, are examples. As such, the Figures (FIGS.) and the detailed description are not to be considered limiting, and other equally effective examples are possible and likely. Furthermore, like reference numerals (“ref.”) in the FIGS. indicate like elements, and wherein:

FIG. 1A is a system diagram illustrating an example communications system;

FIG. 1B is a system diagram illustrating an example wireless transmit/receive unit (WTRU) that may be used within the communications system illustrated in FIG. 1A;

FIG. 1C is a system diagram illustrating an example radio access network (RAN) and an example core network (CN) that may be used within the communications system illustrated in FIG. 1A;

FIG. 1D is a system diagram illustrating a further example RAN and a further example CN that may be used within the communications system illustrated in FIG. 1A;

FIG. 2A is a diagram illustrating an example of a communication between an Access Point (AP) and stations (STA) of a Wireless Local Area Network (WLAN), in which one or more disclosed embodiments may be implemented;

FIG. 2B is a system diagram of an example wireless local area network (WLAN) in which one or more disclosed embodiments may be implemented;

FIG. 2C illustrates groups of stations;

FIGS. 2D and 2E illustrates methods implemented in device and AP of FIG. 2A;

FIG. 3 is a diagram illustrating an example of an access to a transmission channel for transmission of low latency traffic;

FIGS. 4 and 5 are diagrams illustrating examples of Low Latency Traffic Information (LLTI) according to different embodiments; and

FIG. 6 illustrates a Low Latency element according to an embodiment.

### DETAILED DESCRIPTION

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components and circuits have not been described in detail, so as not to obscure the following description. Further, embodiments and examples not specifically described herein may be practiced in lieu of, or in combination with, the embodiments and other examples described, disclosed or otherwise provided explicitly, implicitly and/or inherently (collectively “provided”) herein. Although various embodiments are described and/or claimed herein in which an apparatus, system, device, etc. and/or any element thereof carries out an operation, process, algorithm, function, etc. and/or any portion thereof, it is to be understood that any embodiments described and/or claimed herein assume that any apparatus, system, device, etc. and/or any element thereof is configured to carry out any operation, process, algorithm, function, etc. and/or any portion thereof.

### Example Communications System

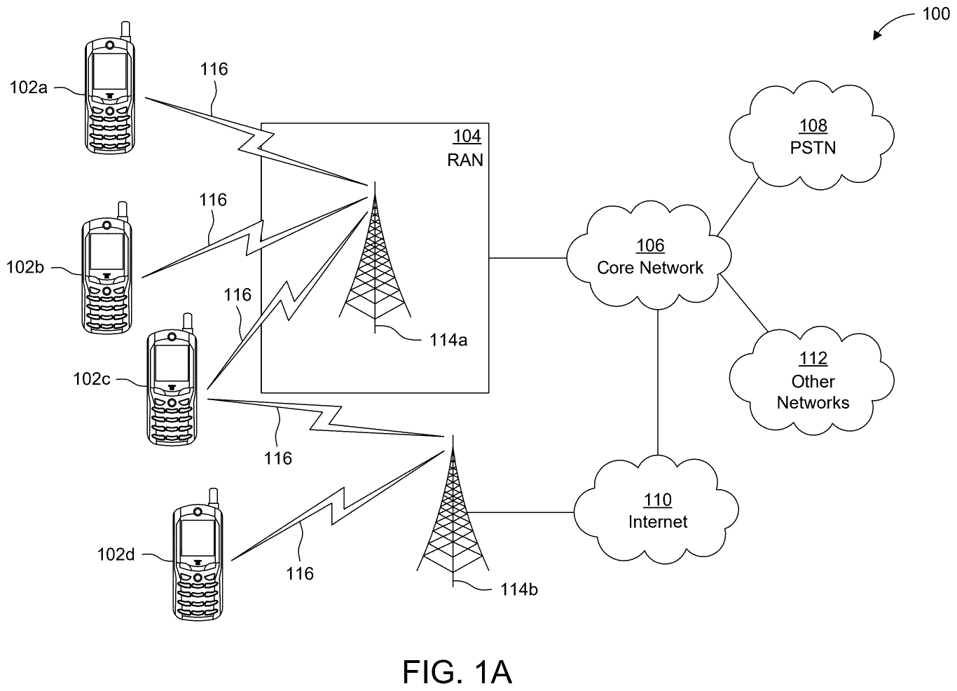

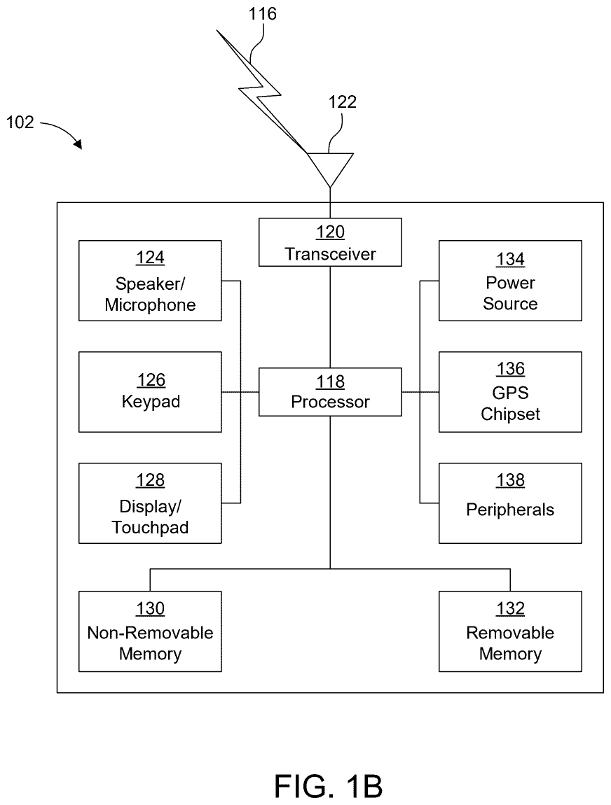

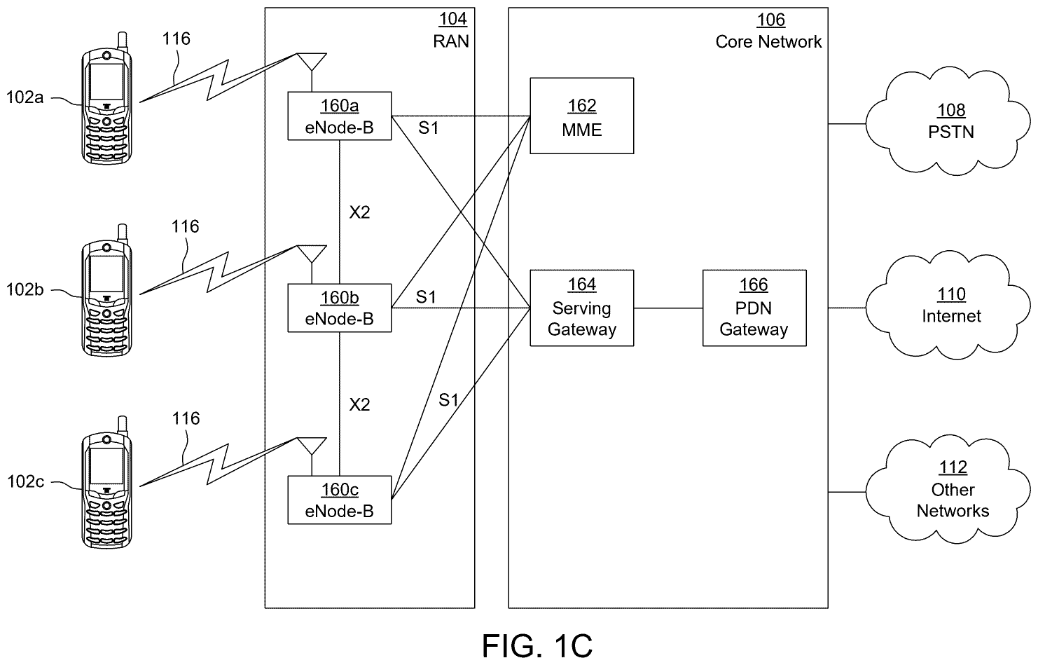

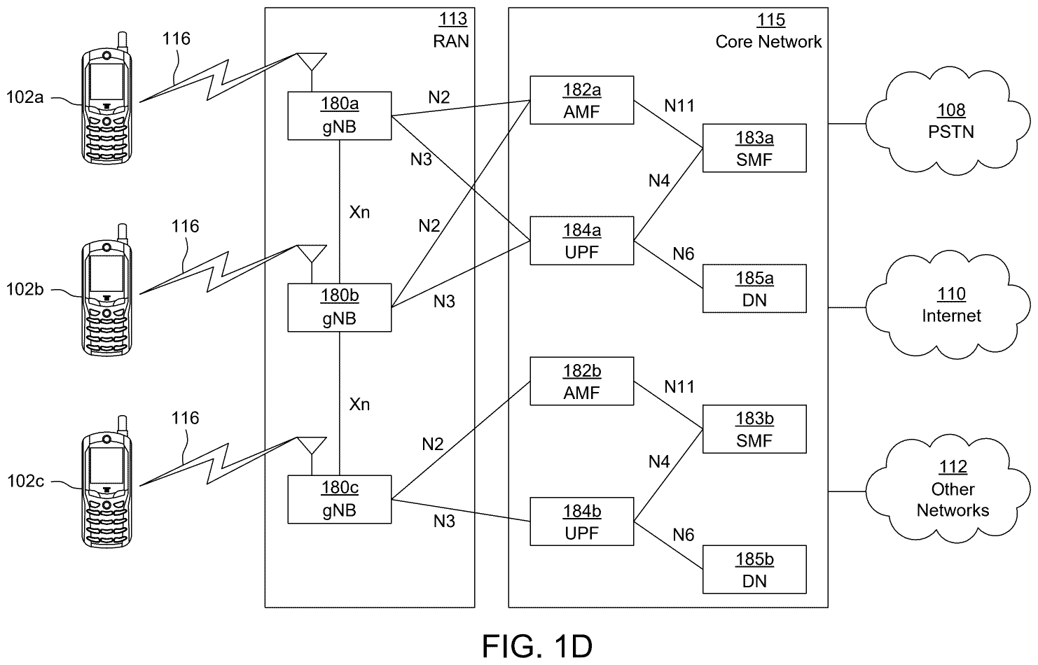

The methods, apparatuses and systems provided herein are well-suited for communications involving both wired and wireless networks. An overview of various types of wireless devices and infrastructure is provided with respect to FIGS. 1A-1D, where various elements of the network may utilize, perform, be arranged in accordance with and/or be adapted and/or configured for the methods, apparatuses and systems provided herein.

FIG. 1A is a system diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail (ZT) unique-word (UW) discrete Fourier transform (DFT) Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (and/or a “STA”), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device (e.g., gaming devices), a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to, for example, facilitate access to one or more communication networks, such as the CN 106, the Internet 110, and/or the other networks 112. By way of example, the base stations 114a, 114b may be a base transceiver station (BTS), a Node B, an eNode-B (eNB), a Home Node-B (HNB), a Home eNode-B (HeNB, a next generation Node-B (NR NB), such as a gNode-B (gNB), a new radio (NR) Node-B, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in an embodiment, the base station 114a may include three transceivers, i.e., one for each sector of the cell. In an embodiment, the base station 114a may employ multiple-input multiple output (MIMO) technology and may utilize multiple transceivers for each or any sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode-B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In an embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VOIP) services to one or more of the WTRUs 102a, 102b, 102c, 102d. The data may have varying quality of service (QOS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or Wi-Fi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. For example, the WTRU 102 may employ MIMO technology. Thus, in an embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 160a, 160b, 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, the gNBs 180a, 180b, 180c may utilize beamforming to transmit signals to and/or receive signals from the WTRUs 102a, 102b, 102c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., including a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards user plane functions (UPFs) 184a, 184b, routing of control plane information towards access and mobility management functions (AMFs) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one session management function (SMF) 183a, 183b, and at least one Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and/or the like. The AMF 182a, 182b may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering DL packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In an embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, base stations 114a-b, eNode-Bs 160a-c, MME 162, SGW 164, PGW 166, gNBs 180a-c, AMFs 182a-b, UPFs 184a-b, SMFs 183a-b, DNs 185a-b, and/or any other element(s)/device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

An AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off for a certain period of time before sensing again. One STA (e.g., only one station) may transmit at any given space, time and frequency resource in a given BSS.

In other representative embodiments, an AP may assign bandwidth resources over which associated STAs communicate with the AP. Bandwidth resources may include one or more channels (i.e., contiguous, or non-contiguous), one or more subchannels within a channel, one or more resource units (RUs) within an Orthogonal Frequency division Multiple Access (OFDMA) system, whereby assigned one or more RUs may be adjacent (i.e., contiguous) or non-contiguous, occupying one or more channels or subchannels, etc.

High Throughput (HT or 802.11n) STAs may use a 40 MHz wide channel for communication, for example, via a combination of the primary 20 MHz channel with an adjacent or nonadjacent 20 MHz channel to form a 40 MHz wide channel.

Very High Throughput (VHT or 802.11ac) STAs may support 20 MHz, 40 MHz, 80 MHZ, and/or 160 MHz wide channels transmitted over a 5 GHz frequency band using OFDMA. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

High Efficiency Wireless (HEW or 802.11ax) STAs may support 20 MHz, 40 MHz, 80 MHz, and/or 160 MHz wide channels capable of transmission over 2.4 GHz, 5 GHZ, and 6 GHz frequency bands using both OFDMA and multi-user multiple-input multiple-output (MU-MIMO) capabilities. OFDMA subcarrier modulation in HE STAs includes formats such as BPSK, QPSK, 16-QAM, 64-QAM, 256-QAM, 1024-QAM. The evolution of 802.11 to Extremely High Throughput (EHT) STAs extends to having 320 MHz wide channels.

While earlier generation 802.11 STAs (e.g., HEW or 802.11ax) could decide to transmit on one of the 2.4, 5.0, or 6 GHz bands, EHT STAs are further capable of multi-link operation (MLO), whereby data transmission between an EHT AP and STA STAs can occur over multiple bands simultaneously (e.g., 5 GHz and 6 GHz) thus increasing throughput and/or reliability. EHT STAs also benefit from a jump in QAM modulation from 1024-QAM to 4K-QAM, while enabling peak data rates of around 46 Gbps compared to the 9.6 Gbps capabilities of HEW STAs.

The next generation of 802.11 standard, 802.11bn (i.e., Ultra High Reliability-UHR) explores the possibility to improve reliability, support further reduced low latency traffic, further increase peak throughput, improved power saving capabilities and improve efficiency of the IEEE 802.11 network over HEW. These improvements are driven by technological advancements such as 360 immersive video, ultra-high-resolution streaming, online gaming, remote surgery, rapid expansion of Internet of Things (IoT), etc. Other 802.11 standard development examples are directed to areas such as: the application and management of artificial intelligence and machine learning (AIML) in WLANs, expanding WiFi communications into the millimeter-wave frequency band (integrated millimeter-wave-IMMW), energy harvesting based on of WiFi RF signals for facilitating WLAN communications of low-power IoT devices, and the randomization of MAC addresses in WLANs.

For the sake of clarity, satisfying, failing to satisfy a condition, and configuring condition parameter(s) are described throughout embodiments described herein as relative to a threshold (e.g., greater, or lower than) a (e.g., threshold) value, configuring the (e.g., threshold) value, etc. For example, satisfying a condition may be described as being above a (e.g., threshold) value, and failing to satisfy a condition may be described as being below a (e.g., threshold) value. Embodiments described herein are not limited to threshold-based conditions. Any kind of other condition and parameter(s) (such as e.g., belonging or not belonging to a range of values) may be applicable to embodiments described herein.

Throughout embodiments described herein, (e.g., configuration) information may be described as received by a WTRU from the network, for example, through system information or via any kind of protocol message. Although not explicitly mentioned throughout embodiments described herein, the same (e.g., configuration) information may be pre-configured in the WTRU (e.g., via any kind of pre-configuration methods such as e.g., via factory settings), such that this (e.g., configuration) information may be used by the WTRU without being received from the network.

Throughout embodiments described herein, the expression “the WTRU may be configured with a set of parameters” is equivalent or may be used interchangeably with “the WTRU may receive configuration information (e.g., from another network element (e.g., gNB)) indicating a set of parameters”. Throughout embodiments described herein, the expressions “the WTRU may report something”, and “the WTRU may be configured to report something”, is equivalent or may be used interchangeably with “the WTRU may transmit (e.g., reporting) information indicating something”.

In embodiments described herein, ‘a’ and ‘an’ and similar phrases are to be interpreted as ‘one or more’ and ‘at least one’. Similarly, any term which ends with the suffix ‘(s)’ is to be interpreted as ‘one or more’ and ‘at least one’. The term ‘may’ is to be interpreted as ‘may, for example’.

A symbol ‘/’ (e.g., forward slash) may be used herein to represent ‘and/or’, where for example, ‘A/B’ may imply ‘A and/or B’.

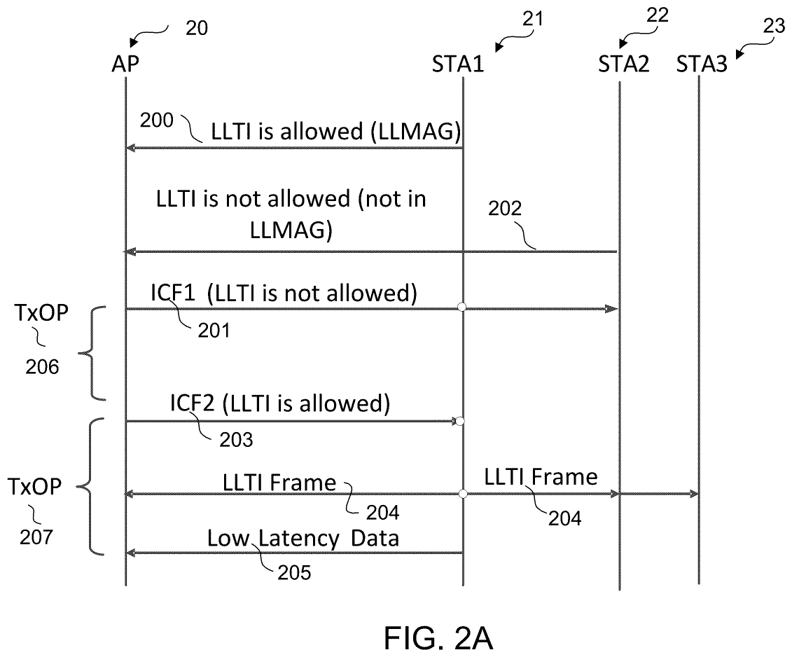

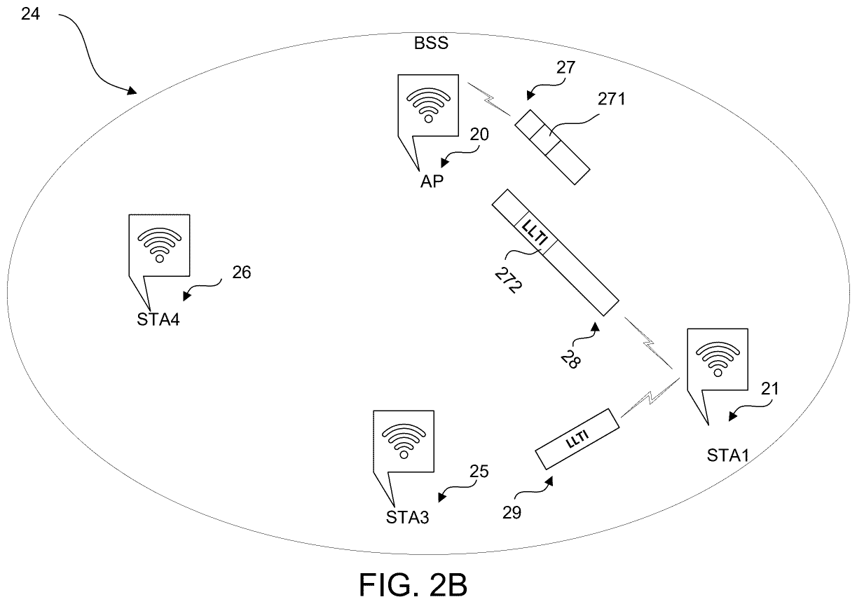

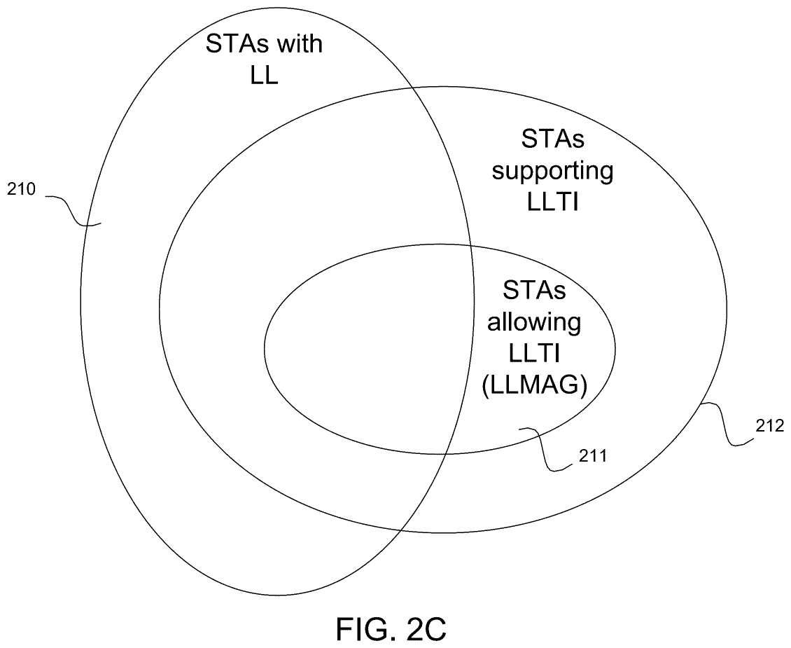

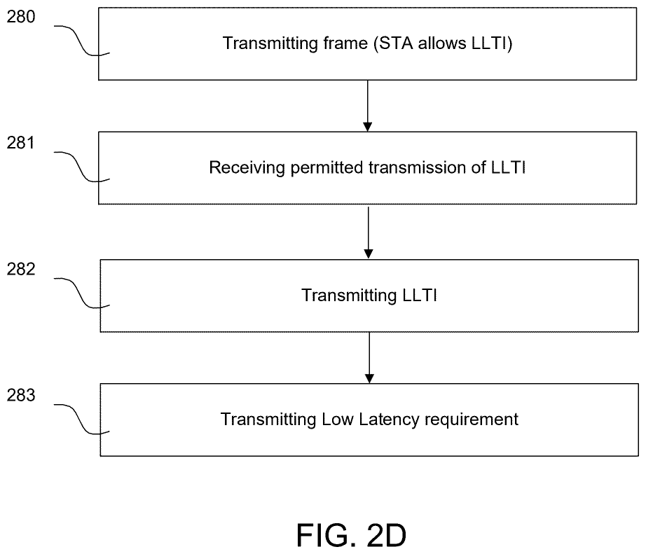

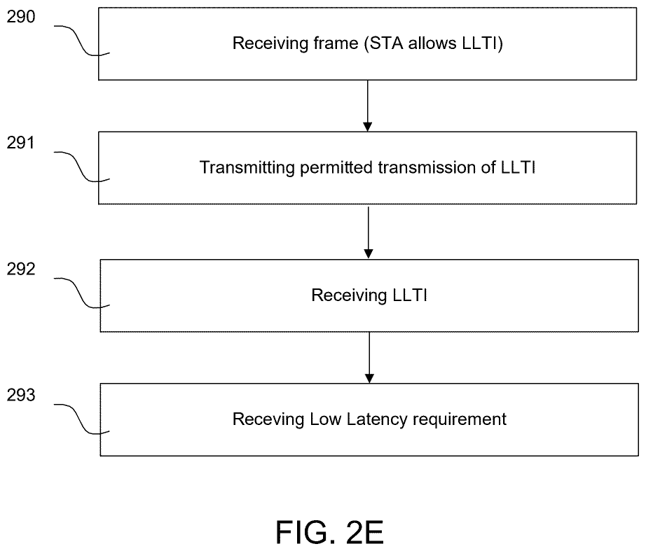

FIG. 2A shows an example of traffic between stations STA1 21, STA2 22, STA3 23 and an Access Point (AP) 20. In an embodiment, the Station STA1 21 sends to the AP 20 information 200 indicating that it allows low latency traffic indication (LLTI) transmissions. According to an embodiment, this information 200 may be transmitted in a frame that may be at least one of a control frame, a management frame, or a data frame. Alternatively, Station STA2 22 sends, to the AP 20, information 202 indicating that it does not allow LLTI transmissions. The AP 20 may then send an initial control frame (ICF) to both STA1 21 and STA2 22 indicating that LLTI transmission is not allowed during the first transmit opportunity (TXOP) 206. During a subsequent TXOP 207 following TX 206, the AP 20 send another second ICF frame 203 to STA1 21 indicating that LLTI transmission is now allowed during TXOP 207. Upon receiving the second ICF frame 203, STA1 21 then sends (i.e., broadcasts) an LLTI frame to the other STAs in the BSS, such as AP 20, and STAs 22 and 23. Once STA1 21 has restricted transmissions/medium access by other STAs based on the broadcast LLTI frame 204, it transmits its low latency data to the AP 20. It may be appreciated that the transmission of TXOP 206 and 207 are independent to each other such that TXOP 207 does not necessarily occur based on TXOP 206.

These embodiments may enable an efficient transmission from a STA to an AP of traffic having a low latency requirement. They also may enable a simple implementation of STA and AP for low-latency traffic communication. Low latency data or communication has a lower latency requirement relative to other data traffic, which may have higher latency requirement or no latency requirement.

802.11bn group is targeting to provide support for low latency traffic. A number of medium access schemes have been proposed including Defer Signals, deterministic backoff and TXOP pre-emptions. These proposals include methods to allow stations with low latency traffic to act aggressively to obtain the wireless medium. Such aggressive behaviors need to be well managed by the network. The embodiments as disclosed in FIG. 2A to 2E may provide effective designs that can manage the aggressive medium access algorithms needed to provide low latency traffic the short delay that it needs while allowing sufficient fairness for other type of traffic and legacy stations.

Traffic with low-latency requirement may originate from many real time applications, which may have stringent requirements in terms of latency and jitter along with certain reliability constraints. Such traffic is referred to as latency sensitive traffic. Latency sensitive traffic may require packets to be delivered with predictable latency in terms of both its average and the worst case values over a wireless link.

Latency requirements may be defined as a latency threshold; low latency is lower than the threshold. This threshold may be defined as a specific value (e.g. 1 ms). Multiple values of threshold may be defined to enables different priorities among traffic having a low-latency requirement, the lower the threshold is, the higher the priority is. The AP may take into account different priorities to enable access to the channel for a TxOP.

FIG. 2D is a diagram illustrating an example method for use in the station (STA) 21, the method comprising:
transmitting, to the Access Point (AP) 20, a frame comprising one or more fields or subfields for indicating the STA allows Low Latency Traffic Indicator (LLTI) communications with a first group of other STAs associated with the AP that support the Low Latency Traffic Indicator (LLTI) communications;
receiving, from the AP, a first control frame indicating a permitted transmission of LLTI communications during a first TXOP 207;
transmitting, an LLTI signal during the first TXOP 207; and
transmitting, data having a low latency requirement relative to other data traffic based on the transmitted LLTI frame.

FIG. 2E is a diagram illustrating an example method for use in the access point (AP) 20, the method comprising:
receiving, from a station (STA), a frame comprising one or more fields or subfields for indicating the STA allows Low Latency Traffic Indicator (LLTI) communications with a first group of other STAs associated with the AP that support the Low Latency Traffic Indicator (LLTI) communications;
transmitting, to the STA, a first control frame indicating a permitted transmission of LLTI communications during a first TXOP 207;
receiving, an LLTI signal during the first TXOP 207; and
receiving, data having a low latency requirement relative to other data traffic based on the received LLTI signal.

### Low Latency Traffic Channel Access

According to existing channel access procedures, IEEE 802.11 stations (STAs) usually perform a random backoff procedure before transmitting for each contention period.

When a STA with a frame queued for transmission determines that the wireless medium is idle and the wireless medium remains idle for a period of a Distributed Inter-Frame Space (DIFS) or an Extended Inter-Frame Space (EIFS) from the end of the immediately preceding medium-busy event, the STA may invoke a random backoff procedure. The STA may start transmitting if the wireless medium remains idle after a backoff counter at the STA, which was set to a randomly chosen initial value, decrements down to 0. The backoff counter is set to an integer value chosen randomly with a uniform distribution between 0 to CW[AC], where CW is an integer value between aCWmin and aCWmax, and AC is an index corresponding to an access category (e.g., voice, video, best effort, background). aCWmin and aCWmax are values set by the AP. The STA (AP or non-AP) will set the initial value of CW to aCWmin. CW is doubled when a collision or transmission failure occurs but is capped by aCWmax. CW is reset to aCWmin after every successful transmission. If no medium activity is indicated for the duration of a particular backoff slot, then the backoff procedure shall decrement its backoff counter.

Low latency traffic is referred as traffic for which it may be necessary or desirable to meet, for example, certain delay and/or jitter requirements.

A STA with low latency traffic may have higher priority to access the wireless medium. For example, the STA may be allowed to transmit a special signal without backoff procedure, or with limited backoff procedure. Right after the special signal, only STAs which has low latency traffic and/or transmitted the special signal may be able to contend the wireless medium. The special signal may be referred as a Low Latency Traffic Indication signal (LLTI). Here the limited backoff procedure may refer to the backoff procedure with higher priority, and/or lower backoff counter etc. After the transmission of the LLTI, the STA may be able to transmit its low latency traffic. Or the STA may need to perform a short random backoff to acquire the wireless medium and then transmit its low latency traffic. The later method is designed to deal with the case that more than one STAs may transmit the LLTI concurrently. The STAs which did not transmit the LLTI may not be able to contend and access the channel right after the LLTI transmission.

In one method, STAs may indicate their capabilities to support transmission and reception of the LLTI. A Low Latency Mutual Assisted group (LLMAG) may be defined as a group of STAs which are willing to perform LLTI transmissions and meanwhile willing to support other STAs in the group to perform LLTI transmissions (i.e., allow other STAs in the group to transmit LLIT to interrupt its potential transmission). Note not all STAs with low latency traffic is willing to join the LLMAG since the traffic transmission with lower priority or lower latency requirement may be interrupted by the LLTI transmission. Whether a STA determines to join the LLMAG may be implementation dependent. The STA may determine that based on its traffic status and network conditions. For example, if a STA may predict frequent low latency traffic in the near future and there is not many STAs in the network are using LLTI, the STA may determine to join the LLMAG.

A relationship between the STAs with low latency traffic, the STAs which have LLTI transmission capability (supporting LLTI), the STAs which allowing LLTI transmissions (i.e., in the LLMAG) is shown in FIG. 2C. STAs supporting LLTI may form a set which is static or semi-static. In another word, it may be capability related, and if a STA has the LLTI capability, it may be in the set. The STAs in the LLMAG may form a set which is a subset of the set of STAs with LLTI capability. Note, this set may be dynamic and STAs may join or disjoin the set dynamically. The STAs with low latency traffic may form another set which may have intersection with the other two sets. Some STAs may have low latency traffic but not supporting LLTI or not in the LLMAG. For example, legacy STAs may have low latency traffic but not supporting LLTI. Some STAs may have low latency traffic and support LLTI, but may not allow LLTI transmission (i.e., not in the LLMAG). Some STAs may not have low latency traffic yet, but it may predict to have low latency traffic soon, and they may joint LLMAG in advance. The STA set with low latency traffic is a dynamic set which may change from time to time.

Relationship between the STAs with low latency traffic, the STAs which have LLTI transmission capability, the STAs which allowing LLTI transmissions (i.e., in the LLMAG) is illustrated in FIG. 2C.

A first group 210 includes stations with Low Latency requirements.

A second group 212 includes stations supporting LLTI or have LLTI capability. The second group 212 includes a third group (LLMAG) 211 including stations allowing LLTI. There may be station belonging to the second group 212 and not to the third group 211.

Stations of the first group 210 may not support LLTI and would be outside the second group 212. Stations of the first group 210 may support LLTI and would be in the second group 212. Stations of the first group 210 may allow LLTI and would be in the third group 211.

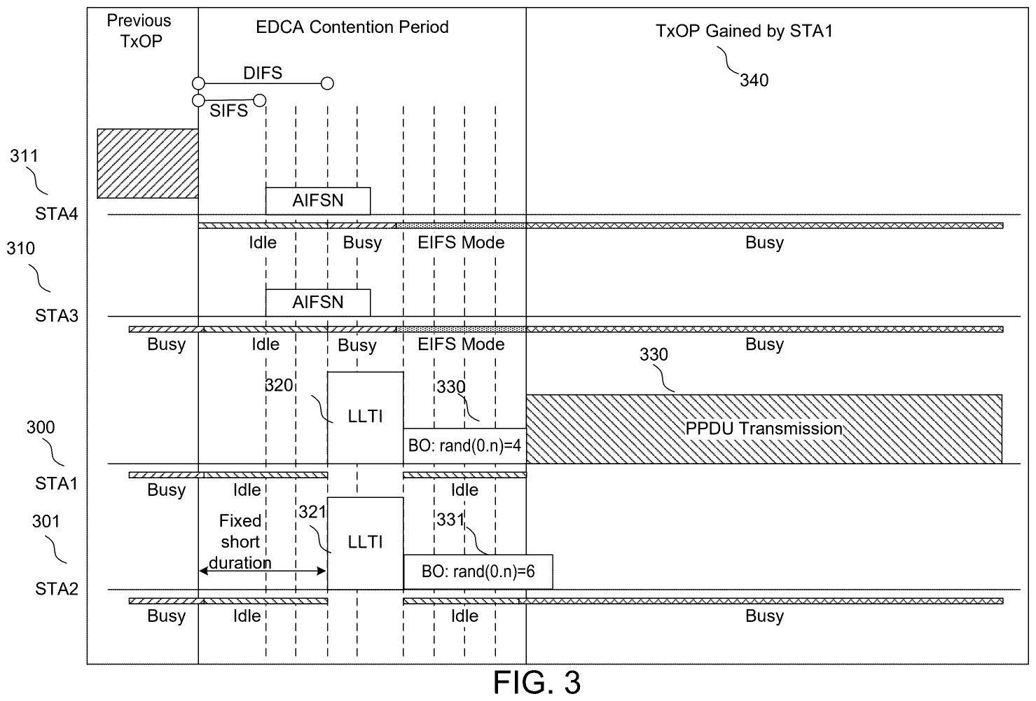

As illustrated in FIG. 3, to support low latency traffic transmission, one approach is to allow a STA (e.g. STA1 300 and STA2 302) with low latency to transmit an LLTI signal 320, 321 without backoff in a contention period. After the reception of the LLTI Signal transmitted from one or more stations with low latency traffic, other stations (e.g., STA3 310 and STA4 311) without low latency traffic may hold their contention and wait for the next transmission opportunity (TXOP). If two or more STAs concurrently transmit the LLTI Signal, they may start a backoff procedure in order to reduce the chance of collision. In the example of FIG. 3, STA1 300 and STA2 301 concurrently transmit an LLTI signal 320, 321 and start a backoff procedure. STA1 300 with a random backoff of 4 in a range of 0 to n gains the TXOP against STA2 301 with a random backoff of 6, and can thus transmit a PPDU 330 during the gained TXOP 340.

A purpose of the LLTI, or the like, is to give STAs with low latency traffic a chance to access the medium in an aggressive way, in that the transmission of the LLTI is without any backoff. Any aggressive STA, however, regardless of the type of traffic (low latency or not) it may have, can always transmit the LLTI at the beginning of a contention period. If there is one such aggressive STA in a BSS, it will always be able to occupy the medium whenever it wants. If there is a group of such aggressive STAs in a BSS, this group of STA MLDs will always have a higher priority to access the medium than the other stations in the BSS. If all the STA MLDs in a BSS are aggressive, then the situation is like traditional channel access, except that the LLTI is always transmitted, unnecessarily, and becomes an additional overhead for any contention period. Therefore, to give STAs with low latency traffic high priority to access the medium by using a LLTI, or the like, while still maintaining a certain degree of fairness among devices in the network and preventing intentionally aggressive STA MLDs from occupying the medium unnecessarily, a flexible control mechanism is desirable.

In a WLAN, it may be desirable that a STA with low latency traffic enjoy higher priority to access the wireless medium than a station without low latency traffic. In representative embodiments in accordance with the present disclosure, a STA in LLMAG, with low latency traffic can transmit such traffic with limited or no backoff by first transmitting a signal referred to herein as a Low Latency Traffic Indication (LLTI), LLTI signal, or LLTI frame. An LLTI frame may include an indication of upcoming low latency traffic transmission and restrict communications from STAs which did not transmit the LLTI frame.

More than one STA may transmit the LLTI concurrently. The LLTI may be transmitted without backoff. After the LLTI is transmitted, STA s which have low latency traffic and/or had transmitted the LLTI may be able to contend for the wireless medium. Limited backoff may entail using a backoff procedure with higher priority, and/or a lower backoff counter (e.g., lower Cmin/Cmax values), etc. After transmission of the LLTI, a STA may perform a backoff procedure, in which it randomly determines a backoff period, senses the wireless medium for any transmission activity thereon, and if in that backoff period does not sense any such activity, may then proceed to transmit its low latency traffic on the wireless medium.

A station without low latency traffic or which has not transmitted the LLTI may withhold transmission after detecting transmission of an LLTI from other devices. For example, after it detects an LLTI, a STA without low latency traffic may defer its channel access.

The aforementioned procedures may be allowed in a certain period of time or duration, such, as for example, within a TXOP, within a beacon interval, or for any contention period, which may be given dynamically or semi-statically.

FIG. 2B shows an example WLAN 24 including the AP 20, STA 21, and STAs 25 and 26. The WLAN 24 is in Infrastructure Basic Service Set (BSS) mode, with STAs 21, 25 and 26 and the AP 20 considered to constitute a BSS. In the illustrative scenario depicted in FIG. 2B, the AP 20 sends a LLTI element 271 indicating information associated with low latency communication in a transmitted frame 27 such as a beacon frame. Upon receiving frame 27, the STA1 21 may send a responding transmission 28 to the AP 20 indicating LLTI capability information 272 that it allows LLTI transmissions. Upon authorization of LLTI communications by the AP 20, the STA1 21 may then broadcast an LLTI frame 29 to all other STAs (i.e., STA3 25, STA4 26, AP 20) to capture the medium for its low latency data transmission.

The STAs which are capable of transmission and reception of the LLTI may indicate if they are willing to join the LLMAG. If an AP is communicating with STAs that belong to the LLMAG in an TXOP, the AP may allow the transmission of the LLTI and, therefore, the PPDU carrying the Low latency traffic within the TXOP; otherwise, the AP may disallow the transmission of the LLTI within the TXOP.

STAs with capabilities of supporting the transmission of the LLTI may use one field/subfield to indicate whether they intend to join the LLMAG or allow its TXOP to be interrupted by the LLTI transmission. We may refer the field/subfield as LLTI Allowed field/subfield. The STAs (e.g., non-AP STA) may indicate that in a management frame such as Probe Request frame, (Re) Association Request frame, or an Action frame. Or The STAs may indicate that in a control/data frame. Or the STAs may indicate that in the MAC header, e.g., using A-Control field, HT Control field, QoS Control field etc., of a management/data/control frame.

STAs may stay in the LLMAG (or out of the LLMAG) after it indicated that in the LLTI Allowed field/subfield in a frame. STAs may be able to change the setting of this LLTI Allowed field/subfield by transmitting another frame containing the field/subfield. In one method, the STAs may be able to change the setting of the LLTI Allowed field/subfield under certain conditions by transmitting another frame containing the field/subfield. For example, if the STA is not a TXOP responder or the STA will not be a TXOP responder in certain time, it may change its willingness to join or disjoin the LLMAG. STAs may determine the setting of the LLTI Allowed field/subfield based on its traffic characteristics, its network congestion conditions or other type of criteria. It may be STA's implementation to decide the value of the field/subfield.

In one method, an AP 20 may send an LLTI inquiry to its intended receiving STAs or TXOP responders or associated STAs to check if they may allow LLTI in the TXOP or an upcoming TXOP/service period. For example, the AP may transmit an LLTI Inquiry frame to solicit if a STA or a group of STAs may be part of the LLMAG or allow LLTI transmission in the TXOP or an upcoming TXOPs.

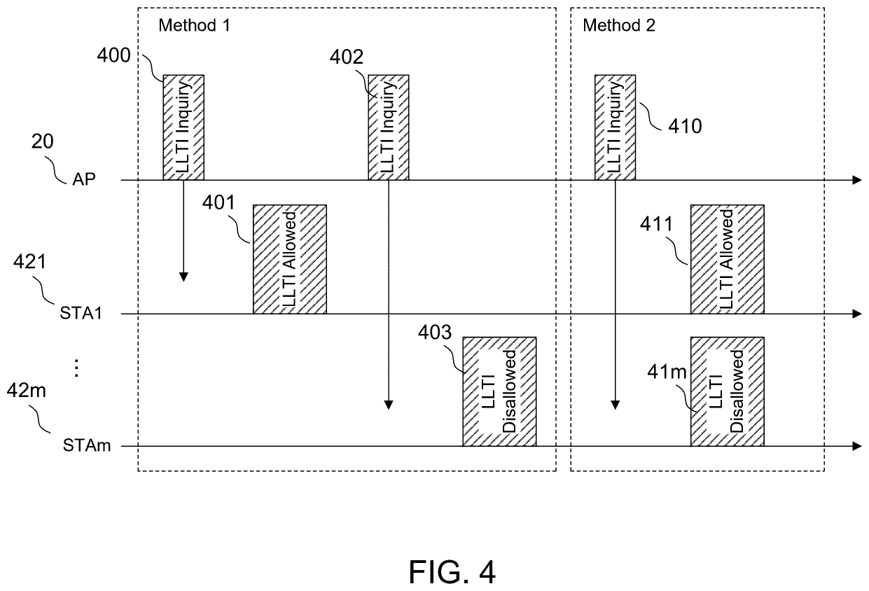

FIG. 4 illustrates different methods of inquiry of LLTI. For example, in an embodiment (method 1), the AP 20 may send a first LLTI inquiry 402 to a Station STA1 421, which may respond to the AP 20 in a frame 401 that LLTI is allowed for this station STA1 421; then, AP 20 may send a second LLTI inquiry 402 to a Station STA2 42m, which may respond that LLTI is disallowed for this station STAm 42m. In another embodiment (method 2), the AP 20 may send LLTI inquiry in a broadcast way to one or more STAs (STA 421 and STA 42m in the example shown in FIG. 4). And one or more STAs may respond the LLTI inquiry concurrently using OFMDA or UL MU-MIMO format. The AP 20 may send an LLTI inquiry 410 to a subset of stations in the BSS (that may depend on the nature of the stations, their address, the type of traffic generated by the stations, their current status or all stations in the BSS, STA1 421 to STAm 42m. In an embodiment, the AP 20 may send inquiries to stations which support LLTI or have LLTI capability, or STAs belonging to LLMAG, or STAs outside the LLMAG but LLTI capable. STA1 421 to STAm 42m may send respectively responses 411 to 41m, specifying whether the LLTI is allowed or disallowed. to the AP 20. In an embodiment, the AP 20 may register the LLTI status (eg. LTTI allowed or disallowed) of each inquired station. The inquiry may solicit other information such as whether the STA has or will have low latency traffic, traffic with certain delay bound, traffic type etc. In another word, the inquiry frame may solicit the responder to report traffic delay bound, traffic type, traffic size etc. The frame may be a control frame (e.g., a Trigger frame) or other type of frames with LLMAG inquiry/request. If the inquiry is for a future TXOP/service period, the frame may carry the start time and time duration of the future TXOP/service period. The STA(s) may respond with a control frame or an action frame with the LLTI Allowed field/subfield or LLMAG indication or a frame where the MAC header (e.g., A-Control field) may carry the LLTI Allowed field/subfield or LLMAG indication. FIG. 4 shows two exemplary methods. With method 1, the LLTI inquiry and respond may be transmitted sequentially. With method 2, the LLTI Inquiry may be transmitted to more than one STAs and trigger the concurrent responses from multiple STAs. Besides LLTI Allowed field/subfield, the responding frame may carry other information such as traffic delay bound, traffic type, traffic size etc.

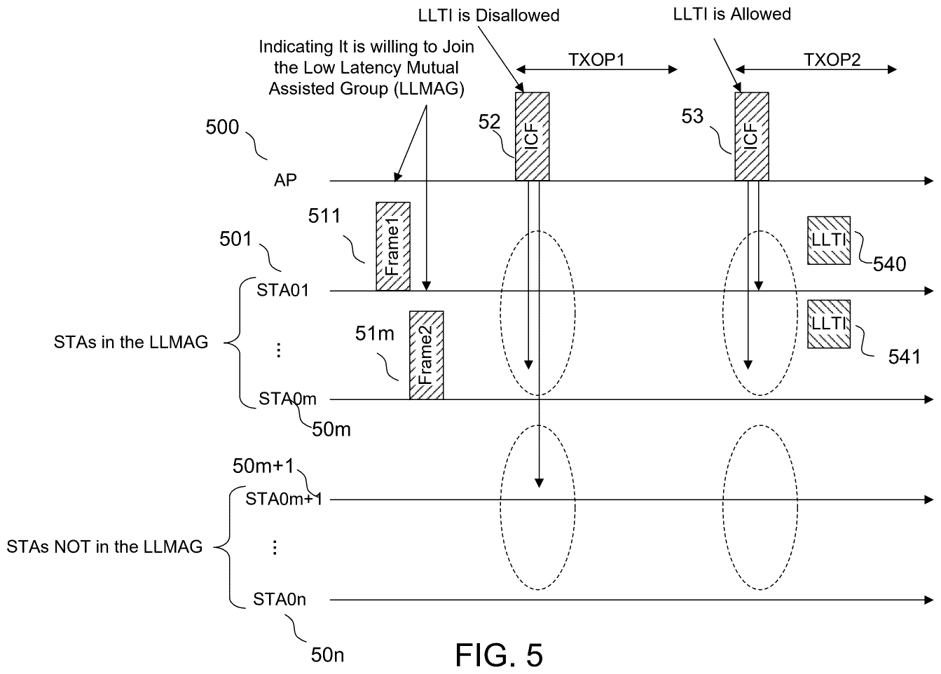

In one method, STAs (e.g., non-AP STAs) may send the LLTI Allowed field/subfield in an unsolicited way. In another word, STAs may transmit a control/action/management/data frame with LLTI Allowed field/subfield or LLTI Allowed fields/subfield in the MAC header in a data/control/management frame without solicitation. STAs which do not transmit the LLTI Allowed field/subfield may be considered as STAs which do not allow LLTI transmission or do not in the LLMAG. FIG. 5 shows an example of unsolicited LLTI Allowed field/subfield transmission. In this example, STA1 and STAm transmit frames with LLTI Allowed field/subfield to indicate they are willing to join the LLMAG. With the unsolicited method, besides LLTI Allowed field/subfield, the frame may carry other information such as traffic delay bound, traffic type, traffic size etc.

In one method, the AP may transmit some information to help the STA to determine whether it may joint LLMAG. For example, the AP may broadcast the number of STAs in the LLMAG, and/or average channel access/transmission delay of using LLTI from time to time. A non-AP STA may want to join the LLMAG if the number of STAs in the LLMAG is small and/or the average channel access delay using LLTI is small; otherwise, it may not want to join the LLMAG. The number of STAs in the LLMAG field/subfield, and/or Average Channel Access Delay field/subfield may be carried in a low latency related element or field which may be carried in a Beacon frame or other type of management frame, action frame or control frame.

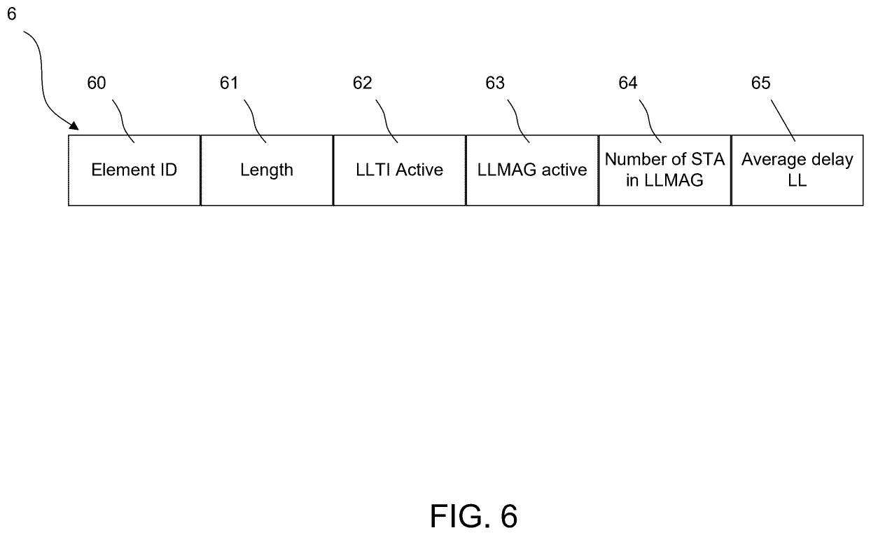

FIG. 6 illustrate a Low Latency management element 6 format, which includes:
An element ID field 60 that may indicate this is a Low Latency Management element; a length field 61 that may indicate the length of the element 6;
an LLTI Active field 62 that may indicate whether LLTI transmission is allowed in the BSS;
an LLMAG Active field 63 that may indicate whether the LLMAG is formed and allowed in the BSS;
a number of STAs in LLMAG field 64 may indicate the number or quantized number of STAs in the LLMAG; and
an average Delay for Low Latency Traffic field 65 may indicate the average delay for general low latency traffic and/or the average delay for the low latency traffic delivered by transmitting the LLTI and/or the average delay for the low latency traffic delivered by not using the LLTI procedure.

In one example, when both LLTI and LLMAG are active, then LLMAG based LLTI transmission is allowed in the BSS. When LLTI is active and LLMAG is not active, then LLTI transmission may be allowed without the restriction of joining the LLMAG group. When LLTI is not active, then LLMAG field may be reserved and the LLTI transmissions are not allowed in the BSS.

The AP may acquire the wireless medium and start a TXOP or a service period. The AP may have a set of intended receivers of the TXOP. The AP may determine if it may allow or disallow the LLTI in the TXOP. For example, it may use one of the rules below:

If all the intended receivers are within the LLMAG or indicated they allow the LLTI to interrupt their transmission/reception, the AP may allow the LLTI in the TXOP by transmitting an initial control frame with the LLTI Allowed field/subfield setting to 1 (as shown in the TXOP2 in FIG. 5). If one of the intended receivers are not within the LLMAG or indicated they disallow the LLTI to interrupt its transmission/reception, the AP may disallow the LLTI in the TXOP by transmitting an initial control frame with the LLTI Allowed field/subfield setting to 0 (as shown in the TXOP1 in FIG. 5).

If at least one intended receiver is within the LLMAG or indicated it allows the LLTI to interrupt its transmission/reception, the AP may allow the LLTI in the TXOP by transmitting an initial control frame with the LLTI Allowed field/subfield setting to 1. If none of the intended receivers is within the LLMAG or indicated they allow the LLTI to interrupt its transmission/reception, the AP may disallow the LLTI in the TXOP by transmitting an initial control frame with the LLTI Allowed field/subfield setting to 0.

If no receiver is within the LLMAG or indicated it allows the LLTI to interrupt its transmission/reception, the AP may disallow the LLTI in the TXOP by transmitting an initial control frame with the LLTI Allowed field/subfield setting to 0. If some of the intended receivers is within the LLMAG or indicated they allow the LLTI to interrupt its transmission/reception, the AP may choose to allow or disallow the LLTI in the TXOP by transmitting an initial control frame with the LLTI Allowed field/subfield setting to 1 or 0.

The initial control frame may be transmitted in a broadcast way or groupcast way so that all the associated UHR/UHR+ STAs may be able to understand the information.

Since the LLTI is per TXOP based (i.e., the STAs may not transmit LLTI out of the boundary of the TXOP), TXOP duration may need to be indicated in the ICF frame. In one method, the Duration field in the MAC header or the TXOP field in the SIG field in the PPDU which carries the ICF may indicate the TXOP duration. In one method, TXOP duration may be explicitly carried in the MAC frame body of the ICF.

On reception of the initial control frame, a STA (e.g., non-AP STA) may retrieve the LLTI Allowed field/subfield.

If the AP allows the LLTI in the TXOP,
STAs in the LLMAG or STAs that allowed the LLTI to interrupt its transmission/reception may transmit the LLTI in the TXOP if they have low latency traffic. This means even STAs which are not intended receiver of the TXOP but in the LLMAG may allow to transmit the LLTI to interrupt the existing transmission in the TXOP. The STAs may use the TXOP duration to determine whether it is within the TXOP boundary and allowed to transmit LLTI.
STAs not in the LLMAG or STAs that disallowed the LLTI to interrupt its transmission/reception are not allowed to transmit the LLTI in the TXOP.

If the AP disallows the LLTI in the TXOP, the STAs are disallowed to transmit the LLTI in the TXOP.

FIG. 5 illustrates an exemplary procedure of Mutually Respected Low Latency Access.

A BSS includes an AP 500, stations STA01 501 to STA0m 50m in an LLMAG and stations STA0m+1 50m+1 to STA0n 50n outside the LLMAG.

According to the scenario, first, the LLMAG is empty and stations STA01 501 to STA0m 50m, each indicates that they are willing to join the Low Latency Mutual Assisted Group (LLMAG) in frames 511 to 51m. In TXOP1, the AP 500 send a control frame (e.g. an Initial Control Frame (ICF)) 52 to all stations STA01 501 to STA0n 50n. Then, in TXOP2, the AP 500 send a control frame (e.g. an Initial Control Frame (ICF)) 53 to stations STA01 501 to STA0m 50m indicating that there are allowed to join the LLMAG group and allowed to use LLTI with priority allocated to LLMAG stations. As members of LLMAG the stations STA01 501 to STA0m 50m may transmit an LLTI signal 540, 541 and start a backoff procedure to access the channel.

In one method, a non-AP STA may be allowed to transmit the LLTI during a TXOP when the TXOP holder is an AP.

While this disclosure refers to “low latency traffic,” the methods and apparatuses disclosed herein are not limited to low latency traffic, but may also be implemented for other types of high priority traffic, traffic for which it may be necessary or desirable to provide high priority transmission, or transmission of a higher priority than non-high priority traffic. As such for example, an indication such as the LLTI described above that can be used for high priority traffic may be referred to as a high priority traffic indication (HPTI) or an indication of high priority traffic, containing some or all of the same information or equivalents thereof as the LLTI.

Various numeric values are used in the present disclosure. The specific values are for example purposes and the aspects described are not limited to these specific values.

Various methods are described herein, and each of the methods comprises one or more steps or actions for achieving the described method. Unless a specific order of steps or actions is required for proper operation of the method, the order and/or use of specific steps and/or actions may be modified or combined. Additionally, terms such as “first”, “second”, etc. may be used in various embodiments to modify an element, component, step, operation, etc. Use of such terms does not imply an ordering to the modified operations unless specifically required. So, in this example, a first operation need not be performed before a second operation, and may occur, for example, before, during, or in an overlapping time period with the second operation.

The implementations and aspects described herein may be implemented in, for example, a method or a process, an apparatus, a software program, a data stream, or a signal. Even if only discussed in the context of a single form of implementation (for example, discussed only as a method), the implementation of features discussed may also be implemented in other forms (for example, an apparatus or program). An apparatus may be implemented in, for example, appropriate hardware, software, and firmware. The methods may be implemented in, for example, an apparatus, for example, a processor, which refers to processing devices in general, including, for example, a computer, a microprocessor, an integrated circuit, or a programmable logic device. Processors also include communication devices, for example, computers, cell phones, portable/personal digital assistants (“PDAs”), and other devices that facilitate communication of information between end-users.

Reference to “one embodiment” or “an embodiment” or “one implementation” or “an implementation”, as well as other variations thereof, means that a particular feature, structure, characteristic, and so forth described in connection with the embodiment is included in at least one embodiment. Thus, the appearances of the phrase “in one embodiment” or “in an embodiment” or “in one implementation” or “in an implementation”, as well any other variations, appearing in various places throughout this disclosure are not necessarily all referring to the same embodiment.

Additionally, this disclosure may refer to “determining” various pieces of information. Determining the information may include one or more of, for example, estimating the information, calculating the information, predicting the information, or retrieving the information from memory.

Further, this disclosure may refer to “accessing” various pieces of information. Accessing the information may include one or more of, for example, receiving the information, retrieving the information (for example, from memory), storing the information, moving the information, copying the information, calculating the information, determining the information, predicting the information, or estimating the information.

Additionally, this disclosure may refer to “receiving” various pieces of information. Receiving is, as with “accessing”, intended to be a broad term. Receiving the information may include one or more of, for example, accessing the information, or retrieving the information (for example, from memory). Further, “receiving” is typically involved, in one way or another, during operations, for example, storing the information, processing the information, transmitting the information, moving the information, copying the information, erasing the information, calculating the information, determining the information, predicting the information, or estimating the information.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as is clear to one of ordinary skill in this and related arts, for as many items as are listed.

As will be evident to one of ordinary skill in the art, implementations may produce a variety of signals formatted to carry information that may be, for example, stored or transmitted. The information may include, for example, instructions for performing a method, or data produced by one of the described implementations. For example, a signal may be formatted to carry the bitstream of a described embodiment. Such a signal may be formatted, for example, as an electromagnetic wave (for example, using a radio frequency portion of spectrum) or as a baseband signal. The formatting may include, for example, encoding a data stream and modulating a carrier with the encoded data stream. The information that the signal carries may be, for example, analog or digital information. The signal may be transmitted over a variety of different wired or wireless links, as is known. The signal may be stored on a processor-readable medium.

Although the features and elements of the present invention are described in the preferred embodiments in particular combinations, each feature or element can be used alone without the other features and elements of the preferred embodiments or in various combinations with or without other features and elements of the present invention. Although the solutions described herein consider 802.11 specific protocols, it is understood that the solutions described herein are not restricted to this specific implementation and are applicable to other wireless systems as well.

Although SIFS may be used to indicate various inter frame spacing in the examples of the designs and procedures, all other inter frame spacing such as RIFS, AIFS, DIFS or other agreed time interval could be applied in the same solutions. A Long Training Field (LTF) may be any type of predefined sequences that are known at both transmitter and receiver sides.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

While not explicitly described, embodiments described herein may be employed in any combination or sub-combination. For example, the present principles are not limited to the described variants, and any arrangement of variants and embodiments can be used.

Besides, any characteristic, variant or embodiment described for a method is compatible with an apparatus device comprising means for processing the disclosed method, with a device comprising circuitry, including any of a transmitter, a receiver, a processor, and a memory, the circuitry being operable (e.g., configured) to process the disclosed method, with a computer program product comprising program code instructions and with a non-transitory computer-readable storage medium storing program instructions.

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

The foregoing embodiments are discussed, for simplicity, with regard to the terminology and structure of infrared capable devices, i.e., infrared emitters and receivers. However, the embodiments discussed are not limited to these systems but may be applied to other systems that use other forms of electromagnetic waves or non-electromagnetic waves such as acoustic waves.

It is also to be understood that the terminology used herein is for the purpose of describing particular embodiments only, and is not intended to be limiting. As used herein, the term “video” or the term “imagery” may mean any of a snapshot, single image and/or multiple images displayed over a time basis. As another example, when referred to herein, the terms “user equipment” and its abbreviation “UE”, the term “remote” and/or the terms “head mounted display” or its abbreviation “HMD” may mean or include (i) a wireless transmit and/or receive unit (WTRU) or STA MLD; (ii) any of a number of embodiments of a WTRU STA MLD; (iii) a wireless-capable and/or wired-capable (e.g., tetherable) device configured with, inter alia, some or all structures and functionality of a WTRU or STA MLD; (iii) a wireless-capable and/or wired-capable device configured with less than all structures and functionality of a WTRU or STA MLD; or (iv) the like. Details of an example WTRU, which may be representative of any WTRU recited herein, are provided herein with respect to FIGS. 1A-1D. As another example, various disclosed embodiments herein supra and infra are described as utilizing a head mounted display. Those skilled in the art will recognize that a device other than the head mounted display may be utilized and some or all of the disclosure and various disclosed embodiments can be modified accordingly without undue experimentation. Examples of such other device may include a drone or other device configured to stream information for providing the adapted reality experience.

In addition, the methods provided herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

Variations of the method, apparatus and system provided above are possible without departing from the scope of the invention. In view of the wide variety of embodiments that can be applied, it should be understood that the illustrated embodiments are examples only, and should not be taken as limiting the scope of the following claims. For instance, the embodiments provided herein include handheld devices, which may include or be utilized with any appropriate voltage source, such as a battery and the like, providing any appropriate voltage.

Moreover, in the embodiments provided above, processing platforms, computing systems, controllers, and other devices that include processors are noted. These devices may include at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (RAM)) or non-volatile (e.g., Read-Only Memory (ROM)) mass storage system readable by the CPU. The computer readable medium may include cooperating or interconnected computer readable medium, which exist exclusively on the processing system or are distributed among multiple interconnected processing systems that may be local or remote to the processing system. It should be understood that the embodiments are not limited to the above-mentioned memories and that other platforms and memories may support the provided methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost versus efficiency tradeoffs. There may be various vehicles by which processes and/or systems and/or other technologies described herein may be effected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples include one or more functions and/or operations, it will be understood by those within the art that each function and/or operation within such block diagrams, flowcharts, or examples may be implemented, individually and/or collectively, by a wide range of hardware, software, firmware, or virtually any combination thereof. In an embodiment, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity, control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components included within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may include usage of the introductory phrases “at least one” and “one or more” to introduce claim recitations. However, the use of such phrases should not be construed to imply that the introduction of a claim recitation by the indefinite articles “a” or “an” limits any particular claim including such introduced claim recitation to embodiments including only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” is intended to include any number of items, including zero. Additionally, as used herein, the term “number” is intended to include any number, including zero. And the term “multiple”, as used herein, is intended to be synonymous with “a plurality”.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke 35 U.S.C. § 112, ¶ 6 or means-plus-function claim format, and any claim without the terms “means for” is not so intended.

What is claimed is:

1. A station (STA) comprising:
a transceiver; and
a processor,
wherein the transceiver and processor are configured to:
transmit, to an Access Point (AP), a frame comprising one or more fields or subfields for indicating the STA allows Low Latency Traffic Indicator (LLTI) communications within a first group of other STAs associated with the AP that allows the low latency traffic Indicator (LLTI) communications;
receive, from an Access Point (AP), a first control frame indicating a permitted transmission of LLTI communications during a first TXOP;
transmit an LLTI signal during the first TXOP; and
transmit, during the first TXOP, data having a low latency requirement following the transmitted LLTI signal.

2. The STA of claim 1, wherein the first control frame is an initial control frame (ICF).

3. The STA of claim 1, wherein the first group allows Low Latency Traffic Indicator (LLTI) communications comprises the first group allowing an interruption of its own transmission by other LLTI communications and transmitting LLTI frames.

4. The STA of claim 3, wherein the first group allows Low Latency Traffic Indicator (LLTI) communications comprises the first group allowing an interruption of its own transmission of data frames, management frames, or control frames by other LLTI communications.

5. The STA of claim 1, further configured to:
receive, from the AP, a frame comprising a low latency management element indicating at least one or more of an average delay value for low latency traffic and a number of STAs within the first group, wherein the STA transmits the frame comprising the one or more fields or subfields for indicating allowance for Low Latency Traffic Indicator (LLTI) communications.

6. The STA of claim 1, wherein the LLTI communications comprises transmission of LLTI frames without random backoff or a reduced backoff time relative to a backoff time used for traffic without low latency requirements.

7. The STA of claim 1, further configured to:
receive, from the AP, a second control frame indicating a disallowed transmission of LLTI communications during a second TXOP, wherein the second control frame temporally occurs before the first control frame and the second TXOP temporally occurs before the first TXOP.

8. The STA of claim 2, wherein the received second initial control frame (ICF) indicating a disallowed transmission of LLTI communications is based on at least one other STA that is associated with the AP being within a second group that is different than the first group of STAs that support LLTI communications.

9. The STA of claim 7, wherein the received second control frame indicating a disallowed transmission of LLTI communications is based on at least one other STA, that is associated with the AP, transmitting, to the AP, a frame indicating that the at least one other STA disallows a LLTI communication to disrupt its transmission or reception.

10. The STA of claim 9, wherein the transmitted frame comprising one or more fields or subfields for indicating the STA supports LLTI communications comprises a control frame or a management frame.

11. The STA of claim 1, wherein the one or more fields or subfields for indicating the STA supports low latency traffic Indicator (LLTI) communications comprises a first binary setting value to indicate the AP allows LLTI communications and a second binary setting value to indicate the AP disallows LLTI communications.

12. A method for use in a station (STA), the method comprising:
transmitting, to an Access Point (AP), a frame comprising one or more fields or subfields for indicating the STA supports Low Latency Traffic Indicator (LLTI) communications with a first group of other STAs associated with the AP that support the Low Latency Traffic Indicator (LLTI) communications;
receiving, from the AP, a first control frame indicating a permitted transmission of LLTI communications during a first TXOP;
transmitting, an LLTI signal during the first TXOP; and
transmitting, data having a low latency requirement relative to other data traffic based on the transmitted LLTI frame.

13. The method of claim 7, further comprising:
receiving, from the AP, a second control frame indicating a non-permitted transmission of LLTI communications during a second TXOP, wherein the second control frame temporally occurs before the first ICF and the second TXOP temporally occurs before the first TXOP.

14. The method of claim 13, wherein the received second control frame indicating a disallowed transmission of LLTI communications is based on at least one other STA that is associated with the AP being within a second group that is different than the first group of STAs that support Low Latency Traffic Indicator (LLTI) communications.

15. The method of claim 13, wherein the received second control frame indicating a disallowed transmission of LLTI communications is based on at least one other STA that is associated with the AP transmitting, to the AP, a frame indicating that the at least one other STA disallows a LLTI communication to disrupt its transmission or reception.

16. The method of claim 15, wherein the transmitted frame comprising one or more fields or subfields for indicating the STA supports LLTI communications comprises a control frame or a management frame.

17. The method of claim 7, wherein the one or more fields or subfields for indicating the STA supports low latency traffic Indicator (LLTI) communications comprises a setting value of ‘1’ to indicate the AP allows LLTI communications and a setting value of ‘0’ to indicate the AP disallows LLTI communications.

18. An access point (AP) comprising:
a transceiver; and
a processor,
wherein the transceiver and processor are configured to:
receive, from a wireless station (STA), a frame comprising one or more fields or subfields for indicating the STA supports Low Latency Traffic Indicator (LLTI) communications with a first group of other STAs associated with the AP that support the Low Latency Traffic Indicator (LLTI) communications;
transmit, to the STA, a first control frame indicating a permitted transmission of LLTI communications during a first TXOP;
receive, an LLTI signal during the first TXOP; and
receive, data having a low latency requirement relative to other data traffic based on the received LLTI signal.

19. The AP of claim 18, further configured to:
transmit, to the STA, a second control frame indicating a disallowed transmission of LLTI communications during a second TXOP, wherein the second ICF temporally occurs before the first control frame and the second TXOP temporally occurs before the first TXOP.

20. A method for use in an access point (AP), the method comprising:
receiving, from a wireless station (STA), a frame comprising one or more fields or subfields for indicating the STA supports Low Latency Traffic Indicator (LLTI) communications with a first group of other STAs associated with the AP that support the Low Latency Traffic Indicator (LLTI) communications;
transmitting, to the STA, a first control frame indicating a permitted transmission of LLTI communications during a first TXOP;
receiving, an LLTI signal during the first TXOP; and
receiving, data having a low latency requirement relative to other data traffic based on the received LLTI signal.
